(19) United States
(12) Patent Application Publication
(10) Pub. No.: US 2025/0308496 A1
(43) Pub. Date: Oct. 2, 2025

(54) MOUTHPIECE AND WIND INSTRUMENT

(71) Applicant: Yamaha Corporation, Hamamatsu-shi (JP)

(72) Inventor: Tetsuro SHOJI, Hamamatsu-shi (JP)

(21) Appl. No.: 19/236,382

(22) Filed: Jun. 12, 2025

Related U.S. Application Data
(63) Continuation of application No. PCT/JP2023/042735, filed on Nov. 29, 2023.

(30) Foreign Application Priority Data
Dec. 26, 2022 (JP) 2022-208973

(51) Int. Cl. G10H 3/16; G10D 9/02; G10H 1/32

(52) U.S. Cl. CPC G10H 3/16; G10D 9/02; G10H 1/32; G10H 2220/361; G10H 2230/221

(57) ABSTRACT

A mouthpiece for a woodwind instrument includes a main body and a first sensor. The main body includes a first space, a second space, a beak, a table, a first opening, and a second opening. The second space is separated from the first space. The table is configured to attach a reed. The first opening is configured to communicate the first space to a space outside the main body, and be at least partly covered by the reed in a state where the reed is attached to the table. The second opening is disposed in an outer surface of the beak and configured to communicate the second space to the space outside the main body. The first sensor is attached to the main body and configured to measure pressure in the second space.

### CROSS-REFERENCE TO RELATED APPLICATIONS

The present application is a continuation application of International Application No. PCT/JP2023/042735, filed Nov. 29, 2023, which claims priority to Japanese Patent Application No. 2022-208973, filed Dec. 26, 2022. The contents of these applications are incorporated herein by reference in their entirety.

### BACKGROUND

The present disclosure relates to a mouthpiece and a wind instrument.

In general, to convert the sound of a wind instrument into an electrical signal, a microphone placed near the instrument is used. The microphone captures the air vibrations that propagate outward as the sound of the wind instrument. Techniques for producing sound by capturing air vibrations within an electronic wind instrument have also been developed. For example, JP 2018-49175 A discloses an electronic wind instrument that emits sound based on detection signals output from a plurality of sensors set on the mouthpiece.

According to JP 2018-49175 A, the sensors inside the mouthpiece detect the pressure in the mouthpiece as the breath pressure. When the performer playing the instrument blows into the mouthpiece, the pressure in the mouthpiece rises later than the performer's intraoral pressure. When detecting the blow based on the pressure in the mouthpiece, this delay in the pressure rise causes a delay in the detection of the blow.

An object of the present disclosure is to detect intraoral pressure.

### SUMMARY

One aspect is a mouthpiece for a woodwind instrument. The mouthpiece includes a main body and a first sensor. The main body includes a first space, a second space, a beak, a table, a first opening, and a second opening. The second space is separated from the first space. The table is configured to attach a reed. The first opening is configured to communicate the first space to a space outside the main body, and be at least partly covered by the reed in a state where the reed is attached to the table. The second opening is disposed in an outer surface of the beak and configured to communicate the second space to the space outside the main body. The first sensor is attached to the main body and configured to measure pressure in the second space.

Another aspect is a wind instrument that includes a mouthpiece and a controller. The mouthpiece includes a first sensor configured to measure a performer's intraoral pressure. The controller is configured to generate an audio signal based on a detection result of the first sensor.

Another aspect is a mouthpiece for a woodwind instrument. The mouthpiece includes a main body. The main body includes a first space, a second space, a table, a first opening, and a second opening. The second space is separated from the first space. The table is configured to attach a reed. The first opening is at least partly covered by a reed in a state where the reed is attached to the table. The second opening is disposed at a distal end of a contact surface of the main body, which contact surface is configured to make contact with a performer's upper lip, so that the second opening becomes disposed more inside of a performer's mouth than a portion of the contact surface, which portion is configured to make contact with the performer's upper lip. The second opening is configured to communicate the second space to a space outside the main body.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a schematic external view of a blowing part 1 according to a first embodiment of the present disclosure;

FIG. 2 is a diagram illustrating a reed and a mouthpiece in the blowing part;

FIG. 3 is a diagram illustrating the blowing part viewed in a first direction from a tip rail side;

FIG. 4 is a diagram illustrating the blowing part viewed in a second direction from a side;

FIG. 5 is a cross-sectional view of the mouthpiece along line A1-A2 shown in FIG. 3;

FIG. 6 is a schematic external view of an electronic musical instrument according to a second embodiment of the present disclosure; and

FIG. 7 is a block diagram illustrating a functional configuration of the electronic musical instrument.

### DETAILED DESCRIPTION

The present specification is applicable to a mouthpiece and a wind instrument.

Embodiments of the present disclosure is described in detail with reference to the drawings. The embodiments shown below are examples and should not be interpreted to limit the present disclosure. In the drawings to be referred to in the description of the embodiments, parts that are identical or similar in function are given the same or similar reference numerals (for example, A or B added to numbers), and repetitive descriptions of these parts may be omitted. For the sake of clarity, the drawings may be schematic, i.e., the dimensional proportions may differ from the actual proportions, or some parts of a configuration may be omitted from the drawings.

The wind instrument mouthpiece in an embodiment has a function to detect user's intraoral pressure. This function is realized by a piezoelectric element that generates a voltage according to the compressive deformation of a porous layer. The configuration of this mouthpiece is described below.

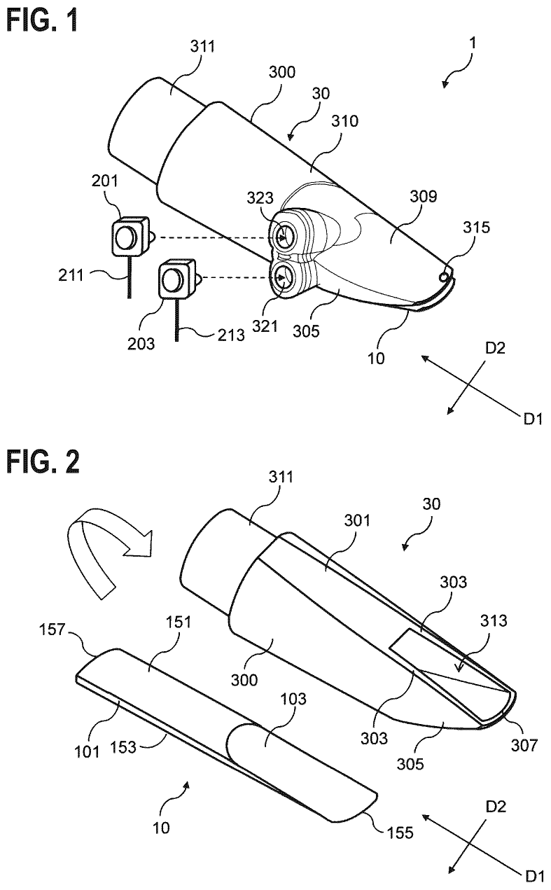

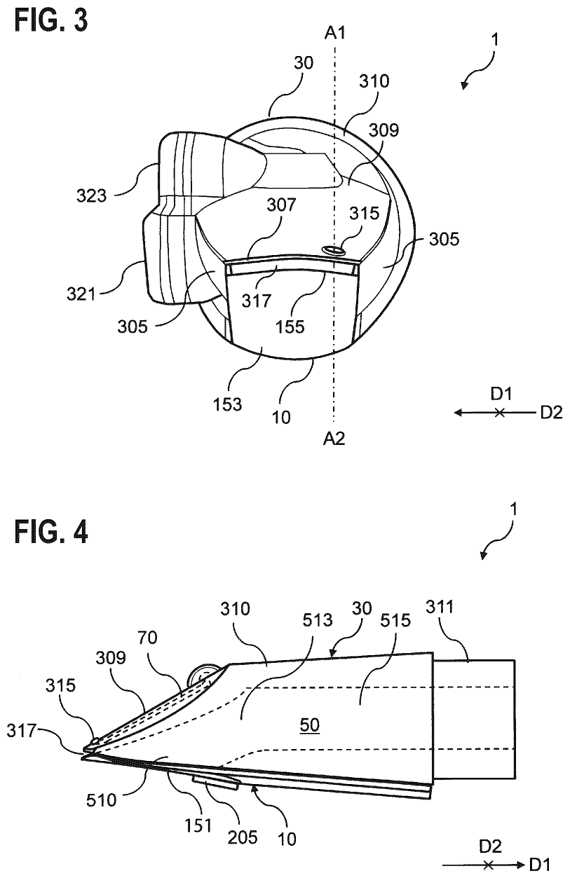

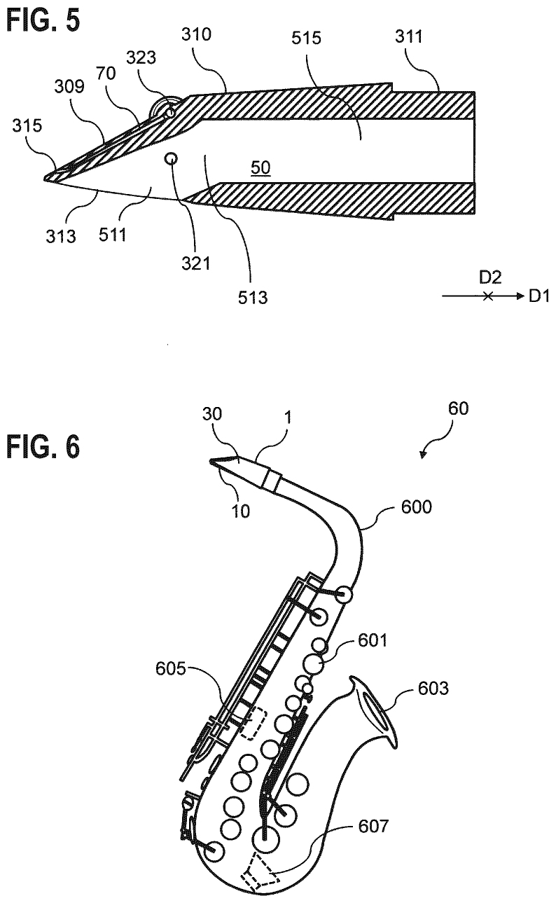

FIG. 1 is a schematic external view of a blowing part 1 according to a first embodiment of the present disclosure. FIG. 2 is a diagram illustrating a reed 10 and a mouthpiece 30 in the blowing part 1. FIG. 3 is a diagram illustrating the blowing part 1 viewed in a first direction D1 from a tip rail side. FIG. 4 is a diagram illustrating the blowing part 1 viewed in a second direction D2 from a side. FIG. 5 is a cross-sectional view of the mouthpiece 30 along line A1-A2 shown in FIG. 3. The first direction D1 is the direction in which the reed 10 and the mouthpiece 30 extend (vertical direction). The second direction D2 is a direction perpendicular to the first direction D1 (horizontal direction).

As shown in FIG. 1, the blowing part 1 includes the reed 10 and the mouthpiece 30. The reed 10 and the mouthpiece 30 are fastened together with a ligature (not shown). The ligature is a part used to securely hold the reed 10 on the mouthpiece 30.

As shown in FIG. 1 and FIG. 2, the mouthpiece 30 includes a main body 300, a first sensor 201, and a second sensor 203. The main body 300 includes a table 301, side rails 303, baffles 305, a tip rail 307, a beak 309, a barrel 310, a shank 311, a window (first opening) 313, and a second opening 315.

The two side rails 303 extend from the table 301. The tip rail 307 extends from the two side rails 303. The tip rail 307 and side rails 303 are located along the edges of the baffles 305. The beak 309 extends from the two baffles 305. The beak 309 is connected to the barrel 310. The shank 311 is positioned on the opposite side from the baffles 305 and the beak 309 on the main body 300 and connected to the barrel 310. The shank 311 functions as a connector that connects to a tube (not shown) of the musical instrument.

The window (first opening) 313 opens on the same side as the table 301, surrounded by the table 301, side rails 303, and tip rail 307. Hereinafter, the window 313 is referred to as the “first opening 313.” The first opening 313 is covered at least partly by the reed 10 when the reed 10 is attached on the table 301. As shown in FIG. 3, a tip opening 317 is formed by the first opening 313 being partly covered by the reed 10.

As shown in FIG. 1 and FIG. 3, the second opening 315 is provided in an outer surface of the beak 309. The second opening 315 is formed in the beak 309 near the tip rail 307 so that it will be positioned inside the user's mouth when the blowing part 1 is placed in the user's mouth. In other words, the second opening 315 is formed at a distal end of a surface that makes contact with the user's upper lip, more inside of the user's mouth than a portion that makes contact with the user's upper lip, when the user (performer) places the blowing part 1 in the mouth. In FIG. 1 and FIG. 3, the second opening 315 is positioned on the right side of the beak 309 when the mouthpiece 30 is viewed from the tip rail 307 side in the first direction D1. This does not mean that the position of the second opening 315 is limited to the right side of the beak 309. The second opening 315 may be provided around the center of the beak 309, or on the left side of the beak 309. By positioning the second opening 315 on the outer surface of the beak 309, physical noise caused, for example, by tonguing, is prevented from being detected by the first sensor 201 to be described later.

As shown in FIG. 4 and FIG. 5, the main body 300 includes a first space 50 and a second space 70. The first space 50 and the second space 70 are formed inside the main body 300. The first space 50 and the second space 70 are separated from each other.

The first space 50 extends from the first opening 313 to the shank 311. The first opening 313 connects the first space 50 to the outside. The first space 50 includes a chamber 511, a throat 513, and a bore 515 from the first opening 313 to the shank 311. The shank 311 may have an opening that connects the bore 515 to the outside. This opening may be connected to the instrument body. In this case, the first space 50 forms a flow passage of the air from the first opening 313 to the shank 311. The air that enters from the tip opening 317 when the user blows in flows through the chamber 511, throat 513, and bore 515 and out of the opening. The shank 311 may have a wall that closes the bore 515.

The second space 70 extends from the second opening 315 to the boundary between the beak 309 and the barrel 310. The second space 70 is separated from the first space 50. The second opening 315 connects the second space 70 to the outside. The volume of the second space 70 is smaller than the volume of the first space 50. In other words, the second space 70 is formed such as to undergo a different pressure change than a pressure change in the first space 50 when the user (performer) blows in air from the tip opening 317 to play a wind instrument to which the mouthpiece 30 is attached.

As shown in FIG. 1, FIG. 3, and FIG. 5, the main body 300 includes, on an outer surface of one baffle 305, a first connection hole (fourth opening) 321 that communicates to the first space 50 and connects the first space 50 to the outside. The main body 300 further includes, on an outer surface near the boundary between the beak 309 and the barrel 310, a second connection hole (third opening) 323 that communicates to the second space 70 and connects the second space 70 to the outside. As shown in FIG. 3, when the mouthpiece 30 is viewed from the tip rail 307 side in the first direction D1, the first connection hole 321 and the second connection hole 323 are positioned on one side of the mouthpiece 30, adjacent and spaced from each other. The positions of the first connection hole 321 and the second connection hole 323 are not limited to this example. Although not shown, the first connection hole 321 may be positioned on one side of the mouthpiece 30 and the second connection hole 323 may be positioned on the other side of the mouthpiece 30 when the mouthpiece 30 is viewed from the tip rail 307 side in the first direction D1. At least one of the first connection hole 321 and the second connection hole 323 may be positioned on the outer surface of the beak 309. At least one of the first connection hole 321 and the second connection hole 323 may be positioned on the outer surface of the barrel 310 or the bore 515.

As shown in FIG. 1, the second connection hole 323 is closed by a first sensor 201. Namely, the second space 70 is formed between the second opening 315 at one end and the second connection hole 323 closed by the first sensor 203 at the other end. Although not shown, the first sensor 201 includes a piezoelectric device that generates an electrical signal according to the applied pressure, an amplifier that amplifies the electrical signal generated by the piezoelectric device, and an outputter that outputs the amplified electrical signal. The piezoelectric device may be in the form of a flexible sheet. The outputter may include a secondary battery as the power supply, or a replaceable primary battery, or a terminal for drawing power from an external source. The first sensor 201 is a pressure sensor that measures the pressure in the second space 70. More specifically, the first sensor 201 measures the pressure of the air flowing into the second space 70 from the second opening 315 when the user blows into the mouthpiece 30 from the tip opening 317. As mentioned above, the second space 70 has a smaller volume than the first space 50. Therefore, a change in pressure in the second space 70 is detected by the first sensor 201 earlier than a change in pressure in the first space 50. In other words, the first sensor 201 measures the user's intraoral pressure when the user blows air into the mouthpiece 30. The electrical signal output from the first sensor 201 is output to external equipment via a wire 211. Although not shown, the first sensor 201 may include a wireless communicator. In this case, the electrical signal output from the first sensor 201 is output to the external equipment via the wireless communicator.

The first connection hole 321 is closed by a second sensor 203. Although not shown, the second sensor 203 includes a piezoelectric device that generates an electrical signal according to the applied pressure, an amplifier that amplifies the electrical signal generated by the piezoelectric device, and an outputter that outputs the amplified electrical signal. The piezoelectric device may be in the form of a flexible sheet. The outputter may include a secondary battery as the power supply, or a replaceable primary battery, or a terminal for drawing power from an external source. The second sensor 203 is a pressure sensor that measures the pressure in the first space 50. More specifically, the second sensor 203 measures the pressure of the air flowing into the first space 50 from the tip opening 317 when the user blows into the mouthpiece 30 from the tip opening 317. In other words, the second sensor 203 measures the pressure in the mouthpiece 30. The electrical signal output from the second sensor 203 is output to external equipment via a wire 213. Although not shown, the second sensor 203 may include a wireless communicator. In this case, the electrical signal output from the second sensor 203 is output to the external equipment via the wireless communicator. In this embodiment, the first connection hole 321 and the second sensor 203 may be omitted. In this case, the mouthpiece 30 does not have a hole that is connected to the first space 50 other than the first opening 313.

In FIG. 1, the first sensor 201 and the second sensor 203 are independently inserted into the second connection hole 323 and the first connection hole 321, respectively. However, this embodiment is not limited to this arrangement. For example, the first sensor 201 and the second sensor 203 may be mounted on a single chip.

Next, the reed 10 is described with reference to FIG. 2. As shown in FIG. 2, the reed 10 includes a base portion 101 and a vamp 103. The base portion 101 includes a flat portion 151, a back side 153, and a heel 157. The flat portion 151 is positioned at least on one side of the base portion 101. In this example, the back side 153 forms at least a part of a flat surface that makes contact with the table 301 when the reed 10 is attached to the mouthpiece 30. The back side 153 is the opposite side from the flat portion 151.

The vamp 103 extends from the base portion 101 on the opposite side from the heel 157. Namely, the vamp 103 is positioned on one end of the first direction D1 (vertical direction) in which the reed 10 extends, reducing in thickness toward the distal end 155.

As shown in FIG. 4, the reed 10 may include a third sensor 205 that is positioned on the flat portion 151 when the reed 10 is attached to the table 301 of the mouthpiece 30. The third sensor 205 measures displacement of the reed 10. More specifically, the third sensor 205 detects vibration of the reed 10 attached to the mouthpiece 30 when the user blows air from the tip opening 317. The third sensor 205 may be any acceleration sensor including, but not limited to, a piezo-resistive acceleration sensor and a capacitance acceleration sensor. In this embodiment, the third second sensor 205 may be omitted.

As described above, the blowing part 1 according to this embodiment includes the mouthpiece 30 with the first space 50 and the second space 70. The mouthpiece 30 includes the first sensor 201 that measures the pressure in the second space 70, and the second sensor 203 that measures the pressure in the first space 50. The user's intraoral pressure can be measured based on the detection result of the first sensor 201 when the user blows air from the tip opening 317 into the mouthpiece 30 with the reed 10 attached. The measured intraoral pressure may be indicated on an external display device to allow the user to check their own intraoral pressure when they blew air into the mouthpiece 30. When the user blows air into the mouthpiece 30, the first sensor 201 detects a pressure change in the second space 70 immediately after the user blew air into the mouthpiece 30, and outputs an electrical signal indicating the pressure in the second space 70. Therefore, when controlling the sound emission from the musical instrument based on the detection results of the first sensor 201, the delay in sound emission can be reduced compared to when the sound emission is controlled based on the pressure in the mouthpiece 30 (i.e., the pressure in the first space 50 detected by the second sensor 203.

### Configuration of Electronic Musical Instrument

FIG. 6 is a schematic external view of an electronic musical instrument 60 according to a second embodiment. The electronic musical instrument 60 includes a blowing part 1 and an instrument body 600. The blowing part 1 is the same blowing part 1 according to the first embodiment, and includes the mouthpiece 30 and the reed 10 attached to the mouthpiece 30.

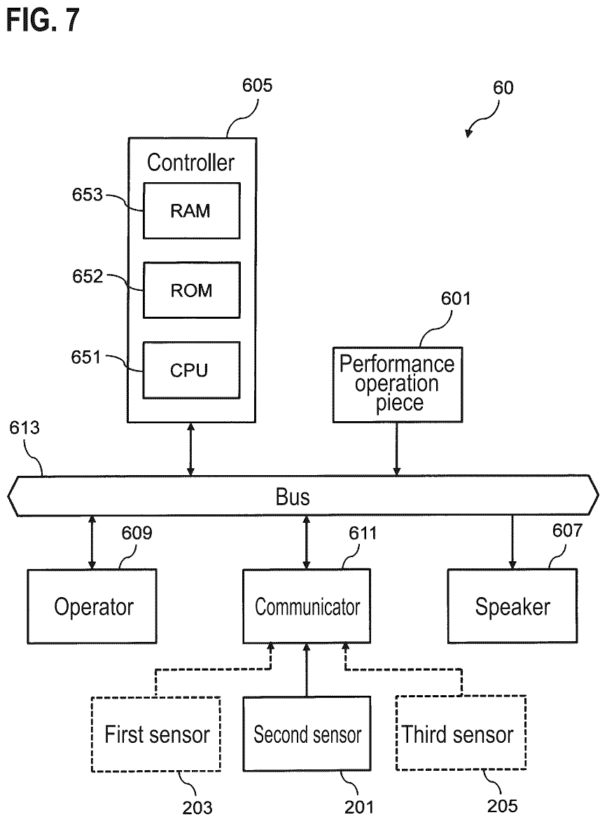

The instrument body 600 has a shape resembling a saxophone, which is an acoustic wind instrument. The instrument body 600 includes multiple performance operation pieces 601 including keys and levers for determining the pitches. The instrument body 600 is tubular, with one end connected to the blowing part 1 and the other end provided with a sound exit 603 where the sound is released. As has been explained with reference to FIG. 4 and FIG. 5, in the case where the shank 311 of the mouthpiece 30 has an opening that connects the bore 515 to the outside, the one end of the instrument body 600 is coupled to the bore 515. In the case where the shank 311 is closed, the one end of the instrument body 600 is not coupled to the bore 515. The instrument body 600 further includes a power switch, an operator 609 including control elements for setting various parameters to control the state of performance, and a communicator 611 that receives electrical signals output from one or more sensors on the mouthpiece 30. The operator 609 and the communicator 611 will be described later with reference to FIG. 7.

The controller 605 and a speaker 607 are arranged inside the instrument body 600. The controller 605 generates an audio signal based on: an electrical signal output from at least one of the first sensor 201, second sensor 203, and third sensor 205 on the mouthpiece 30; performance information based on a performer's operation on the performance operation pieces 601; and a control signal output from the operator 609. In this embodiment, the controller 605 generates an audio signal based on an electrical signal output from the first sensor 203 (hereinafter referred to as a first detection signal). In other words, the controller 605 generates an audio signal based on a detection result of the first sensor 201 (the pressure in the second space 70 of the mouthpiece 30, i.e., the intraoral pressure of the performer playing the electronic musical instrument 60). The speaker 607 emits sound according to the audio signal generated by the controller 605.

FIG. 7 is a block diagram illustrating a functional configuration of the electronic musical instrument 60. As described above, the electronic musical instrument 60 includes one or more sensors on the mouthpiece 30, performance operation pieces 601, controller 605, speaker 607, operator 609, and communicator 611. The sensor(s) on the mouthpiece 30 include(s) at least the first sensor 201. The performance operation pieces 601, controller 605, speaker 607, operator 609, and communicator 611 are interconnected via a bus 613. The sensor(s) on the mouthpiece 30 may include at least one of the second sensor 203 and the third sensor 205.

The controller 605 includes a processor such as a CPU (Central Processing Unit) 651, and storage devices such as a ROM (Read Only Memory) 652 and a RAM (Random Access Memory) 653.

The CPU 651 controls various parts of the electronic musical instrument 60 based on a control program stored in the ROM 652. The ROM 652 stores, in a computer-readable manner, various computer programs to be executed by the CPU 651, and various table data sets that the CPU 651 looks up when executing a predetermined computer program. The computer programs executed by the CPU 651 include a sound generation program to be described later. The ROM 652 stores sound data associated with one or more musical instruments. The sound data is sound wave data obtained by recording the sound of that musical instrument. The sound data may be generated by physical model synthesis. The ROM 652 may be implemented by an external storage device or a storage section of an external server. The RAM 653 is used as a working memory for temporarily storing various pieces of data that is generated during the execution of a predetermined computer program by the CPU 651. Alternatively, the RAM 653 may be used as a memory for temporarily storing the computer program being executed or associated data. The RAM 653 may also temporarily store the first detection signals output from the first sensor 201 and acquired via the communicator 611. The RAM 653 may also temporarily store at least one of an electrical signal output from the second sensor 203 (hereinafter referred to as a second detection signal) and an electrical signal output from the third sensor 205 (hereinafter referred to as a third detection signal).

The operator 609 is an operation button or a touchscreen for receiving user operations. User operations input to the operator 609 cause control signals according to the input operations to be output to the controller 605. The control signals output from the operator 609 contain setting information for setting various parameters to control the performance, and instrument designation information for specifying a desired musical instrument sound.

The communicator 611 is an interface that performs wireless or wired communication with the first sensor 201 on the mouthpiece 30. In the case where at least one of the second sensor 203 and the third sensor 205 is provided on the mouthpiece 30, the communicator 611 may communicate with the at least one of the second sensor 203 and the third sensor 205. The communicator 611 may also communicate with an external device. For example, in the case where the ROM 652 is implemented by an external storage device or a storage section of an external server, the controller 605 retrieves various computer programs, table data, and sound data via the communicator 611.

### Sound Generation Function

The sound generation function implemented by the controller 605 executing a sound generation program is described below with reference to FIG. 7. The configuration for the sound generation function may partly or entirely be implemented by hardware. In this embodiment, the sound generation function is implemented by various parts of the electronic musical instrument 60.

The controller 605 acquires the control signals output from the operator 609 and performance information based on the operations made by the performer on the performance operation pieces 601. The controller 605 further acquires the first detection signal output from the first sensor 201 via the communicator 611. The controller 605 may further acquire one or more of the second detection signal output from the second sensor 203 and the third detection signal output from the third sensor 205 via the communicator 611.

The controller 605 specifies a musical instrument corresponding to the user's preferred timbre based on the instrument designation information contained in the control signals. The controller 605 obtains the sound data associated with the specified musical instrument based on the performance information. More specifically, the controller 605 looks up a data table that maps performance information to sound pitch, identifies the required sound data, and retrieves it from the ROM 652. The controller 605 may further apply various parameters such as envelope for setting the timbre to the sound data based on the control signals.

The controller 605 generates an audio signal according to the sound data based on the first detection signal, and outputs the signal to the speaker 607. More specifically, the controller 605 determines whether the first detection signal meets or exceeds a predetermined threshold. The predetermined threshold is a preset value indicating a predetermined pressure. In other words, the controller 605 determines whether the pressure in the second space 70 of the mouthpiece 30 detected by the first sensor 201, i.e., the performer's intraoral pressure, is equal to or more than a predetermined pressure.

If the first detection signal meets or exceeds the predetermined threshold, the controller 605 calculates a pressure value from the first detection signal using a predefined computation formula and acquires the calculated pressure value as sound volume data. The controller 605 multiplies the acquired sound data with the sound volume data to generate the audio signal. The controller 605 outputs the generated audio signal to the speaker 607. Meanwhile, if the first detection signal is less than the predetermined threshold, the controller 605 does not generate an audio signal.

In this embodiment, the controller 605 generates an audio signal based on the first detection signal, i.e., the detection result of the first sensor 201. As described above, the controller 605 generates an audio signal based on the performance information and outputs the signal to the speaker 607 when the first detection signal meets or exceeds a predetermined threshold. Namely, the controller 605 determines the output timing of the audio signal based on the first detection signal (detection result of the first sensor 201). In other words, the controller 605 determines the timing of sound emission from the electronic musical instrument 60 based on the first detection signal.

When the performer blows air into the mouthpiece 30 to play the electronic musical instrument 60, the air from the performer's mouth flows into the first space 50 and the second space 70 of the mouthpiece 30. Since the second space 70 has a smaller volume than the first space 50, a change in pressure in the second space 70 is detected by the first sensor 201 earlier than a change in pressure in the first space 50. In other words, when the performer blows air into the mouthpiece 30 at or above a predetermined pressure to produce sound from the electronic musical instrument 60, the air is detected earlier when using the detection result of the first sensor 201 than when using the detection result of the second sensor 203. Therefore, by controlling the sound emission from the electronic musical instrument 60 based on the detection result of the first sensor 201, the delay in sound emission can be reduced compared to when sound emission is controlled based on the pressure in the mouthpiece 30 (i.e., the pressure in the first space 50 detected by the second sensor 203).

In this embodiment, the instrument body 600 of the electronic musical instrument 60 was described as having a shape resembling a saxophone, which is an acoustic wind instrument, as one example. However, the shape of the instrument body 600 is not limited to the shape resembling a saxophone.

The present disclosure is not limited to the embodiments described above and includes various other modifications. For example, while the above description of the embodiments provides detailed illustration for easier understanding of the present disclosure, the invention is not necessarily limited to the configuration that includes all of the described features. Some configurations of one embodiment may be replaced by configurations of other embodiments, and some configurations of other embodiments may be added to the one embodiment. Other configurations may be added to some parts of an embodiment, or some configurations of an embodiment may be deleted, or replaced with other configurations. Some modifications are described below.

(1) As described above, the second space 70 in the mouthpiece 30 has a smaller volume than the first space 50. Therefore, a change in pressure in the second space 70 is detected by the first sensor 201 earlier than a change in pressure in the first space. The timing of sound emission from the electronic musical instrument 60 can be adjusted by tailoring at least one of the shape of the second space 70, i.e., the shape from the second opening 315 to the second connection hole 323 in the mouthpiece 30, and the volume of the second space 70. The second space 70 should preferably be designed with a smaller volume than the first space 50 and sized so that pressure fluctuations inside the second space 70 more closely match the fluctuations in the user's intraoral pressure.

(2) In the embodiment described above, the controller 605 of the electronic musical instrument 60 determines not only the timing of sound emission from the electronic musical instrument 60 but also the volume of the sound emitted from the electronic musical instrument 60 based on the first detection signal. This should not be interpreted as limiting; the controller 605 may determine the volume of sound emitted from the electronic musical instrument 60 based on the second detection signal (i.e., the pressure of the first space 50 detected by the second sensor 203). In this case, the controller 605 calculates a pressure value from the second detection signal using a predefined computation formula and acquires the calculated pressure value as sound volume data if the first detection signal meets or exceeds a predetermined threshold. The controller 605 multiplies the acquired sound data with the sound volume data to generate the audio signal, and outputs the signal to the speaker 607.

(3) The sound emission from the electronic musical instrument 60 may be controlled using a trained model that has been trained to learn the relationship between the pressure in the second space 70 detected by the first sensor 201 and the user's preferred sound. The trained model is generated by machine learning and provided to the controller 605. More specifically, the trained model is a pre-trained model with a neural network generated through machine learning. The model is pre-trained on a computer, such as an external server, using training data to learn the correlation between the first detection signal and the sound emitted from the electronic musical instrument 60. The trained model determines the timing of sound emission from the electronic musical instrument 60 based on the first detection signal by performing computations using the neural network. The trained model may also determine the volume of the sound emitted from the electronic musical instrument 60 based on the first detection signal by performing computations using the neural network. In other words, the controller 605 may determine the parameters for processing the audio signal based on the first detection signal using the trained model. The model can be trained to learn the performer's tendencies to allow sound emission from the electronic musical instrument 60 according to the user's preferences. For example, it is possible to produce a user's preferred sound from the electronic musical instrument 60 even when the pressure of the air blown into the mouthpiece 30 by the performer does not reach the threshold actually required to produce sound from the electronic musical instrument 60.

Alternatively, the sound emission from the electronic musical instrument 60 may be controlled using a trained model that has been trained to learn the relationship between the first detection signal and the second detection signal, i.e., the pressure in the second space 70 detected by the first sensor 201 and the pressure in the first space 50 detected by the second sensor 203, and the user's preferred sound. In this case, the configuration is similar to the one described above except that the trained model additionally uses the output from the second sensor 203. The model can be trained to learn the user's tendencies to allow sound emission from the electronic musical instrument 60 according to the user's preferences.

(4) The sound emission from the electronic musical instrument 60 may be controlled using a trained model that has been trained to learn the relationship between the pressure in the second space 70 detected by the first sensor 201 and sound radiation. The trained model is a pre-trained model with a neural network generated through machine learning. The model is pre-trained on a computer, such as an external server, using training data to learn the correlation between the first detection signal and the sound radiation of the electronic musical instrument 60. The trained model selects appropriate sound radiation of the electronic musical instrument 60 based on the first detection signal by performing computations using the neural network. Namely, the controller 605 determines the parameters for processing the audio signal based on the first detection signal using the trained model.

Alternatively, the sound emission from the electronic musical instrument 60 may be controlled using a trained model that has been trained to learn the relationship between the second detection signal, instead of the first detection signal, i.e., the pressure in the first space 50 detected by the second sensor 203, and sound radiation. The trained model is a pre-trained model with a neural network generated through machine learning to learn the correlation between the second detection signal and the sound radiation of the electronic musical instrument 60. The trained model selects appropriate sound radiation of the electronic musical instrument 60 based on the second detection signal by performing computations using the neural network.

Alternatively, the sound emission from the electronic musical instrument 60 may be controlled using a trained model that has been trained to learn the relationship between the third detection signal, instead of the first detection signal, i.e., the deformation of the reed 10 detected by the third sensor 205, and sound radiation. The trained model is a pre-trained model with a neural network generated through machine learning to learn the correlation between the third detection signal and the sound radiation of the electronic musical instrument 60. The trained model selects appropriate sound radiation of the electronic musical instrument 60 based on the third detection signal by performing computations using the neural network.

(5) A model trained to learn the relationship between the first detection signal, i.e., the pressure in the second space 70 detected by the first sensor 201, and sound radiation, may be used to present performance movements to the user during the performance of the electronic musical instrument 60. The trained model is a pre-trained model with a neural network generated through machine learning to learn the correlation between the first detection signal and the sound radiation of the electronic musical instrument 60. The model computes the peak frequencies or spectral centroids from the respective frequency characteristics of predetermined sound radiation and the performer's intraoral pressure (the pressure in the second space 70 detected by the first sensor 201), and calculates the difference between the peak frequency or spectral centroid of the predetermined sound radiation and the peak frequency or spectral centroid of the intraoral pressure. The controller 605 presents the calculated difference to the user, allowing them to check the proper intraoral shape necessary for a performer to produce the preferred sound from the electronic musical instrument 60.

Alternatively, a model trained to learn the relationship between the first detection signal, i.e., the pressure in the second space 70 detected by the first sensor 201, and sound radiation, may be used to present mouthpiece shapes that are suitable for a performer to play the electronic musical instrument 60 to the user. As described above, the model calculates the difference between the peak frequency or spectral centroid of predetermined sound radiation and the peak frequency or spectral centroid of the intraoral pressure of the performer playing the electronic musical instrument 60. The controller 605 calculates a mouthpiece shape that can achieve the preferred sound radiation based on the calculated difference. This allows the user to understand which mouthpiece shape is appropriate for a performer to play the electronic musical instrument 60.

(6) A model trained to learn the relationship between the first detection signal and the third detection signal, i.e., the pressure in the second space 70 detected by the first sensor 201 and the deformation of the reed 10 detected by the third sensor 205, and sound radiation, may be used to present performance movements to the user during the performance of the electronic musical instrument 60. The trained model is a pre-trained model with a neural network generated through machine learning. The model is pre-trained on a computer, such as an external server, using training data to learn the correlation between the sound radiation of a wind instrument when played correctly, and the first detection signal (the performer's intraoral pressure detected by the first sensor 201) and the third detection signal (the deformation of the reed 10). By performing computations using the neural network, the trained model can present to the user the necessary performance movements required to achieve the correct sound radiation of the wind instrument. For example, the controller 605 may display the values of the first detection signal and the third detection signal required to achieve the sound radiation of the wind instrument when played correctly on an external display device. At the same time, the first detection signal value and the third detection signal value obtained while the performer is playing the electronic musical instrument 60 may be displayed on the display device. This allows the user to check, in real time, the correct performance movements required to achieve the preferred sound radiation. Alternatively, by performing computations using the neural network based on the series of first detection signals and third detection signals obtained during a performer's performance of a musical composition on the electronic musical instrument 60, the trained model may provide the user with feedback on the correct performance movements required to achieve the preferred sound radiation. The external display device here may, for example, be a smartphone available to the user.

(7) The ROM 652 of the controller 605 may store table data that maps first detection signal values to sound emission delays for each musical instrument whose sounds can be produced by the electronic musical instrument 60. The controller 605 generates an audio signal based on the sound data of the user's preferred musical instrument, using the control signal that contains the instrument designation information. When outputting the audio signal to the speaker 607, the controller retrieves the sound emission delay specific to the selected musical instrument from the table data and applies it when emitting sound from the electronic musical instrument 60. This enables a single electronic musical instrument 60 to replicate the playing experience of various musical instruments.

(8) The controller 605 may adjust the sound volume according to the RMS value of the first detection signal being output by the first sensor 201 during the sound emission from the electronic musical instrument 60.

(9) The controller 605 may determine the parameters for processing the audio signal based on the third detection signal (i.e., the deformation of the reed 10 detected by the third sensor 205). For example, the controller 605 detects the performer's embouchure based on the third detection signal while the performer is playing the electronic musical instrument 60. The controller 605 adjusts the parameters of the audio signal such that the sound emitted from the electronic musical instrument 60 reflects the detected performer's embouchure.

(10) The controller 605 may detect the performer's tonguing based on the third detection signal while the performer is playing the electronic musical instrument 60, and adjust the parameters of the audio signal such that the sound emitted from the electronic musical instrument 60 reflects the detected performer's tonguing.

(11) In the embodiment described above, the first sensor 201 is attached to the second connection hole 323. Instead, the first sensor 201 may be integral with the mouthpiece 30. The first sensor 201 may be provided inside the second space 70. In this case, the second connection hole 323 in the mouthpiece 30 can be omitted. Similarly, in the case where the mouthpiece 30 has the second sensor 203, the second sensor 203 may be integral with the mouthpiece 30. The second sensor 203 may be provided inside the first space 50. In this case, the first connection hole 321 in the mouthpiece 30 can be omitted.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A mouthpiece for a woodwind instrument, the mouthpiece comprising:
a main body including:
a first space;
a second space separated from the first space;
a beak;
a table configured to attach a reed;
a first opening configured to:
communicate the first space to a space outside the main body; and
be at least partly covered by the reed in a state where the reed is attached to the table; and
a second opening disposed in an outer surface of the beak and configured to communicate the second space to the space outside the main body; and
a first sensor attached to the main body and configured to measure pressure in the second space.

2. The mouthpiece according to claim 1, wherein:
the main body further includes a connection part configured to connect to the woodwind instrument,
the first space provides an air flow passage to the connection part.

3. The mouthpiece according to claim 1, wherein the second space has a smaller volume than a volume of the first space.

4. The mouthpiece according to claim 2, wherein the second space is configured to undergo a different pressure change than a pressure change in the first space, in a state where the main body is attached to the woodwind instrument and the woodwind instrument is played.

5. The mouthpiece according to claim 1, wherein:
the main body includes a third opening configured to communicate with the second space, and
the first sensor is attached to the third opening and closes the third opening.

6. The mouthpiece according to claim 1, further comprising a second sensor configured to measure pressure in the first space.

7. The mouthpiece according to claim 1, further comprising:
the reed attached to the table; and
a third sensor configured to measure deformation of the reed.

8. A wind instrument comprising:
a mouthpiece including a first sensor configured to measure a performer's intraoral pressure; and
a controller configured to generate an audio signal based on a detection result of the first sensor.

9. The wind instrument according to claim 8, wherein the controller determines an output timing of the audio signal based on the detection result.

10. The wind instrument according to claim 8, wherein the controller determines a parameter for processing the audio signal based on the detection result.

11. A mouthpiece for a woodwind instrument, the mouthpiece comprising:
a main body including:
a first space;
a second space separated from the first space;
a table configured to attach a reed;
a first opening that is at least partly covered by a reed in a state where the reed is attached to the table; and
a second opening disposed at a distal end of a contact surface of the main body, which contact surface is configured to make contact with a performer's upper lip, so that the second opening becomes disposed more inside of a performer's mouth than a portion of the contact surface, which portion is configured to make contact with the performer's upper lip, the second opening being configured to communicate the second space to a space outside the main body.
